(19) United States
(12) Patent Application Publication
(10) Pub. No.: US 2011/0302746 A1
(43) Pub. Date: Dec. 15, 2011

(54) BINDING DEVICE

(75) Inventor: Takahiro SANO, Toyohashi-shi (JP)

(73) Assignee: NEWFREY LLC, Newark, DE (US)

(21) Appl. No.: 13/158,946

(22) Filed: Jun. 13, 2011

(30) Foreign Application Priority Data
Jun. 15, 2010 (JP) 2010-136261

(51) Int. Cl. B65D 63/10; B29C 45/00; B65D 63/00

(52) U.S. Cl. 24/16 R; 264/319

(57) ABSTRACT

This invention provides a method for the easy manufacture of a binding device in which resistance in the extraction direction is strengthened by applying an inclination to a movable clasp and ratchet teeth, and provides a binding device manufactured using this manufacturing method. The device includes a band-like body having flexibility and a head portion disposed on an end of the band-like body in the lengthwise direction. The other end of the band-like body in the lengthwise direction is inserted into a through-hole disposed in the head portion to form a loop for securing purposes. The band-like body is connected to the head portion via a curved portion, and an acute angle is formed centered on the curved portion in the direction orthogonal to the insertion direction, etc. of the band-like body into the through-hole.

### CROSS-REFERENCE TO RELATED APPLICATIONS

This application claims priority from Japanese Patent Application No. 2010-136261, filed on Jun. 15, 2010, the disclosure of which is incorporated herein by reference.

### BACKGROUND OF THE INVENTION

The present invention relates to a binding device and, more specifically, to a binding device able to secure an object by wrapping the band portion of the binding device into a loop.

An example of this type of binding device has been disclosed in Patent Document 1, Japanese Published Unexamined Patent Application No. 09-188355. The binding device disclosed includes a slender tongue portion having flexibility and a head portion disposed on one end of the slender tongue portion. The other end of the slender tongue portion is inserted into a through-hole disposed in the head portion to form a loop of the desired size. This loop can secure a bound object such as slender cable or metal rod. In order to secure the loop, a movable clasp is disposed on the inner portion of the through-hole, and a plurality of ratchet teeth are arranged on the surface at the other end of the slender tongue portion in the lengthwise direction of the slender tongue portion so as to correspond to the movable clasp. The movable clasp and the ratchet teeth engage each other inside the through-hole in the head portion, and resistance is generated in the opposite direction of the direction in which the slender tongue portion is inserted into the through-hole (i.e., in the extraction direction) to secure the components.

In the above-mentioned publication, an acute angle is formed in the direction of the extraction load where the movable clasp and the ratchet teeth engage in order to strengthen the resistance in the extraction direction. When the slender tongue portion is inserted into the through-hole, and one of the ratchet teeth engages the movable clasp, the ratchet tooth enters deeply into an accommodation pocket for the ratchet tooth formed by the movable clasp. Similarly, the movable clasp enters deeply into an accommodation pocket for the movable clasp formed by the ratchet tooth. This configuration improves the extraction load (retention strength). A binding device is disclosed in Patent Document 2, U.S. Pat. No. 4,502,187 that uses a similar method to increase the resistance related to extraction. In this publication resistance in the extraction direction is strengthened by applying an inclination to a movable clasp and ratchet teeth. However, how this binding device is made has not been disclosed, and the details of the overall configuration are not at all clear.

An object of the present invention is to provide a method for the easy manufacture of such a binding device, and to provide a binding device manufactured using this manufacturing method.

### SUMMARY OF THE INVENTION

In order to solve this problem, the present invention is a binding device comprising a band-like body having flexibility and a head portion disposed on an end of the band-like body in the lengthwise direction, the other end of the band-like body in the lengthwise direction being inserted into a through-hole disposed in the head portion to form a loop for securing purposes, wherein a plurality of engagement teeth is arranged on the surface of the other end of the band-like body in the lengthwise direction of the band-like body, a movable clasp being disposed on the inner portion of the through-hole corresponding to this, wherein any one of the engagement teeth engages the movable clasp disposed on the inner portion of the through-hole when the other end has been inserted into the through-hole in order to secure the loop, wherein the engagement teeth and the movable clasp are configured so that the movable clasp making an impact is facing the engagement surface of any one of the engagement teeth positioned on the reverse side of the impact surface when the band-like body is inserted into the through-hole, wherein the band-like body is connected to the head portion via a curved portion, and an acute angle is formed centered on the curved portion in the direction orthogonal to both the insertion direction of the band-like body into the through-hole and the extraction direction being the opposite of this, in the molded state before the band-like body has been inserted into the through-hole, and wherein the engagement surfaces of the engagement teeth are formed as a surface running along the insertion direction and the extraction direction.

By providing a curved portion, during the molding process, an accommodation pocket (space) having an acute angle portion with the movable clasp is formed in the engagement surface of the engagement teeth as a natural part of the molding process. When an engagement tooth engages the movable clasp in the acute angle portion, the movable clasp, especially the leading edge side, can bite more deeply into the accommodation pocket. Also, by providing a curved portion, the engagement teeth are sharper than usual. As a result, when an engagement tooth engages the movable clasp, the sharp leading edge side of the engagement tooth can bite more deeply into the accommodation pocket of the movable clasp. In addition, because the engagement surfaces of the engagement teeth are formed as a surface running along the insertion direction and the extraction direction, the injection molding process can be used.

Preferably, in the binding device of the present invention, a portion of the band-like body on which the engagement teeth have been arranged is substantially straight in the molded state before the band-like body has been inserted into the through-hole. This can make the integral molding process easier.

In the binding device of the present invention, the leading edge side of the engagement surface of the movable clasp can be inclined towards the insertion direction. The engagement surface of the movable clasp is used to form an accommodation pocket with an acute angle portion for an engagement tooth. When an engagement tooth engages the movable clasp, the leading edge side of the engagement tooth can bite more deeply into the accommodation pocket.

Preferably, in the binding device of the present invention, a side wall is disposed in the lengthwise direction of the band-like body on both side surfaces of the band-like body. This can increase the strength of the band-like body.

In the binding device of the present invention, a second curved portion can be disposed in the connecting portion between the other end of the band-like body and a portion of the band-like body in which the engagement teeth are arranged for returning the curvature due to the curved portion to the original state. In this way, when the band-like body is inserted into the through-hole, the other end of the band-like body, which is the portion inserted into the through-hole, moves along the insertion direction of the band-like body into the through-hole, thereby improving the insertability of the band-like body into the through-hole.

In the binding device of the present invention, the other end of the band-like body centered on the curved portion can be inclined towards the insertion direction and form an acute angle in the orthogonal direction in the molded state before the band-like body has been inserted into the through-hole. When the binding device is integrally manufactured using injection molding, at least the band-like body portion in which a plurality of engagement teeth are arranged can be manufactured by performing injection molding in the extraction direction.

In the binding device of the present invention, the other end of the band-like body centered on the curved portion can be inclined towards the extraction direction and form an acute angle in the orthogonal direction in the molded state before the band-like body has been inserted into the through-hole. When the binding device is integrally manufactured using injection molding, at least the band-like body portion in which a plurality of engagement teeth are arranged can be manufactured by performing injection molding in the insertion direction.

In the present invention, a binding device can be provided in which the retention strength of the binding device is improved, especially in the extraction direction. Also, this binding device can be easily and inexpensively made.

### BRIEF DESCRIPTION OF THE DRAWINGS

FIG. 1 is a top view of a binding device according to the present invention.

FIG. 2 is across-sectional view from line I-I in FIG. 1.

FIG. 3 is a partially enlarged perspective view of the band in FIG. 1.

FIG. 4 is a partially enlarged view of FIG. 2.

FIG. 5 is a partially enlarged view of FIG. 2.

FIG. 6 is an enlarged view after the band has been inserted into the through-hole.

FIG. 7 is a view of another embodiment of the present invention.

FIG. 8 is a partially enlarged view of FIG. 7.

### DETAILED DESCRIPTION OF THE INVENTION

The following is an explanation of the binding device in a preferred embodiment of the invention in the present application with reference to the appended drawings.

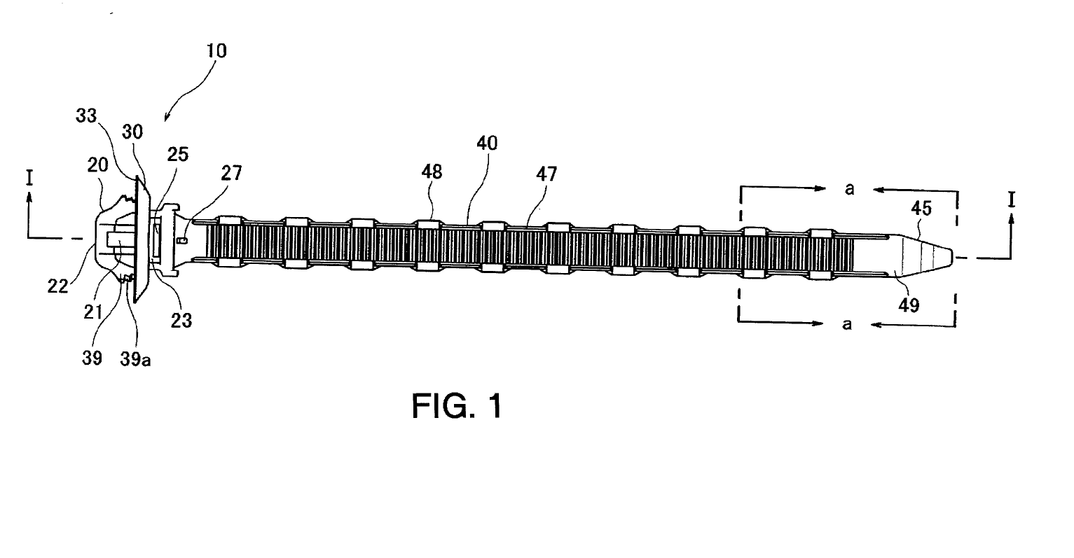

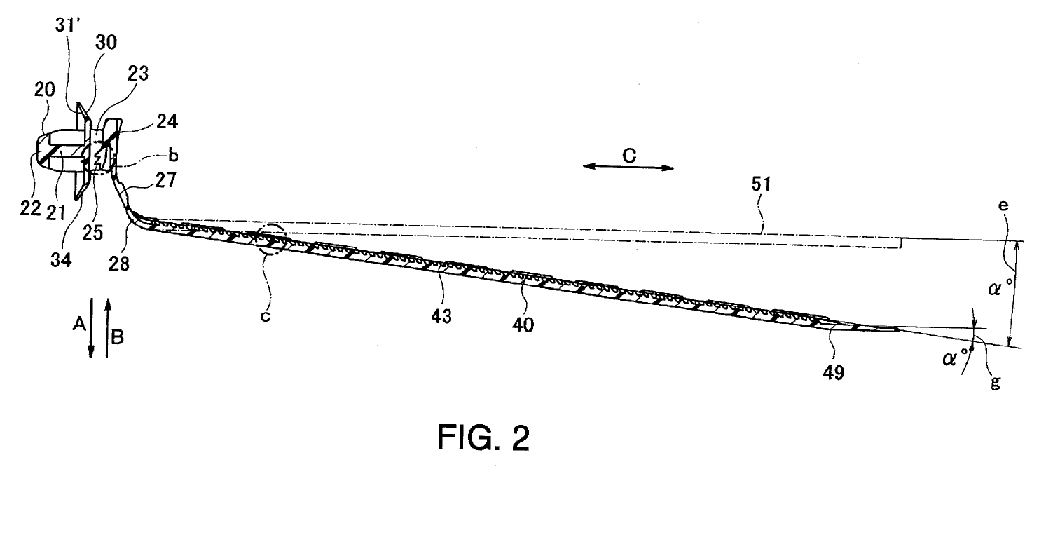

FIG. 1 is a top view of a binding device 10 according to the present invention, and FIG. 2 is a cross-sectional view from line I-I in FIG. 1. The binding device 10 primarily includes a belt-like band 40 having flexibility and a head portion buckle 20 disposed at one end in the lengthwise direction of the band.

The buckle 20 functions as a portion for securing the band 40, and also functions as a portion for securing the binding device 10 to a panel, etc. The configuration serving as the securing portion for a panel is similar to a general binding device. This is explained in greater detail in, for example, Japanese Published Patent Application No. 8-145021. Simply put, in order to secure a panel, the buckle 20 mainly includes a pair of engaging pieces 39 with flexibility connected to a support pillar 21 and bent to the rear from the leading edge 22, a flange 30 arranged near each end of the pair of engaging pieces 39, and a through-hole 23 disposed on the rear side of the flange 30 and having a square cross-section in the horizontal direction (corresponding to the orthogonal direction C relative to the insertion direction A and the extraction direction B). In order to improve the insertability of the band 40 into the through-hole 23, a lead-in portion 31 can be disposed in the upper portion of the flange 30. In order to easily extract the band 40 from the through-hole 23, a lead-out portion 34 can be disposed in the lower portion of the flange 30. When the leading edge 22 of the buckle 20 is inserted into a mounting hole disposed in a mounted panel such as an automotive panel (not shown in the drawing), the engagement tiered portion 39a on the pair of engagement pieces 39 engage the inner peripheral edge of the mounting hole, and the mounted panel is inserted between the engagement tiered portion 39a and the front wall 33 of the flange 30. As a result, the buckle 20 engages the mounted panel and is secured.

The binding device 10 of the present invention can be integrally molded using a process including injection molding. This manufacturing process is easy, and the manufacturing costs are low. The components constituting the binding device 10 corresponding to the shapes and orientations molded using the injection molding process. For example, the upper portion of the band 40 is molded in the vertical direction along the extraction direction B and the lower portion of the band 40 is molded in the vertical direction along insertion direction A to manufacture these components. By using integral molding, the binding device 10 can be manufactured easily and inexpensively.

During use, the side on which the buckle 20 is disposed is the opposite side, and the other end in the band lengthwise direction is inserted into the through-hole 23 of the buckle 20 along the wall surface 32 of the through-hole 23 to form a loop (not shown in the drawing). The component to be bound such as metal wiring (not shown in the drawing) can be secured by securing the band 40 after the loop-shaped band has been wound around the component. FIG. 1 and FIG. 2 show the band 40 as molded before insertion into the through-hole 23. It is not shown during use. Only FIG. 6 described below shows the band 40 inserted into the through-hole 23, that is, during use.

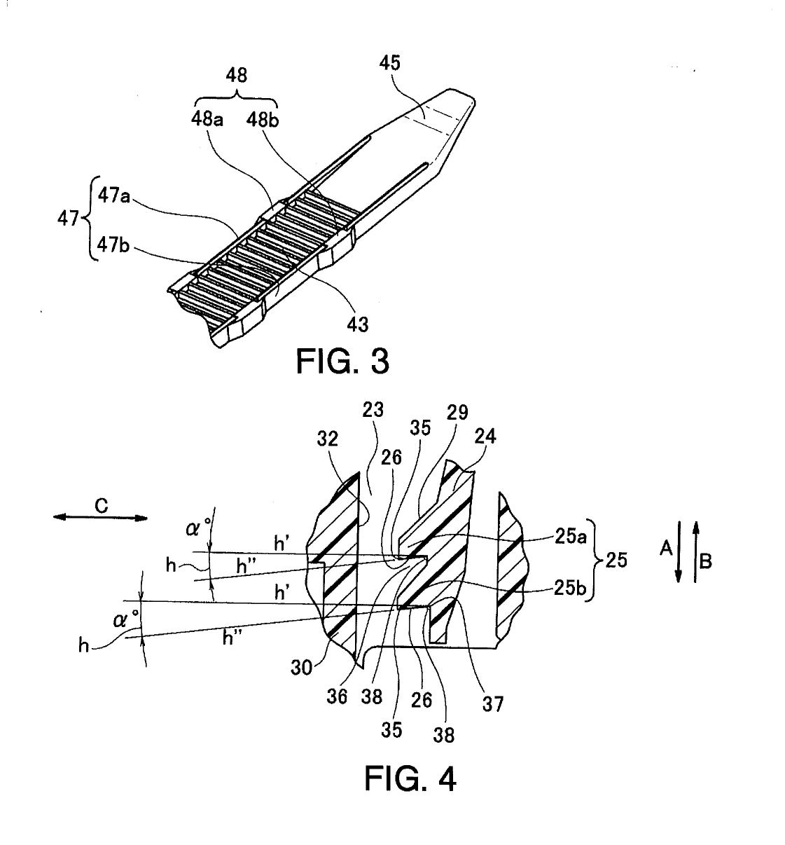

FIG. 3 is a partially enlarged perspective view of portion (a) of the band 40 in FIG. 1. In order to secure the band 40 in the desired position in the through-hole 23, a plurality of ratchet teeth 43 are disposed in the lengthwise direction of the band 40 on the surface at the other end of the band 40. By installing ratchet teeth 43, thick and thin portions are created in the band surface. As a result, the strength of the band 40 is sometimes reduced. However, this problem can be solved by disposing side walls 47 on both side surfaces in the band lengthwise direction.

Opposing protruding portions 48a, 48b protruding outward are disposed on the sides of the side walls 47 along the band lengthwise direction at a predetermined pitch and serve as catches with respect to the through-hole 23 when the band 40 has been inserted into the through-hole 23. These protruding portions 48 work to increase the strength of the band 40. The portion in which the ratchet teeth 43 are disposed is substantially straight in the molded state before the band 40 is inserted into the through-hole 23. In this way, all of the ratchet teeth 43 can be integrally molded with the same shape.

FIG. 4 is an enlarged view of the inner portion of the through-hole 23, or portion (b) in FIG. 2. Buckle clasps 25a, 25b are disposed on the inner portion of the through-hole 23 corresponding to the ratchet teeth 43 of the band 40. These buckle clasps 25a, 25b are rendered movable via a cantilevered beam-shaped movable piece 24, and are elastically displaceable in the direction of arrow C. When the band 40 is inserted into the through-hole 23, the buckle clasps 25a, 25b use elastic action to engage one of the ratchet teeth 43 on the band 40 and to secure the band 40. By securing one of the ratchet teeth 43 with the buckle clasps 25a, 25b, the position of the band 40 in the through-hole 23 can be adjusted and the length of the loop can be set. In this embodiment, there are two buckle clasps 25 (25a, 25b), but there does not have to be two. For example, there can be only one, or there can be three or more. If there is only one, there is a good possibility that engagement will be insufficient. If there are three or more, the mold has to be enlarged. Therefore, two is considered an appropriate number.

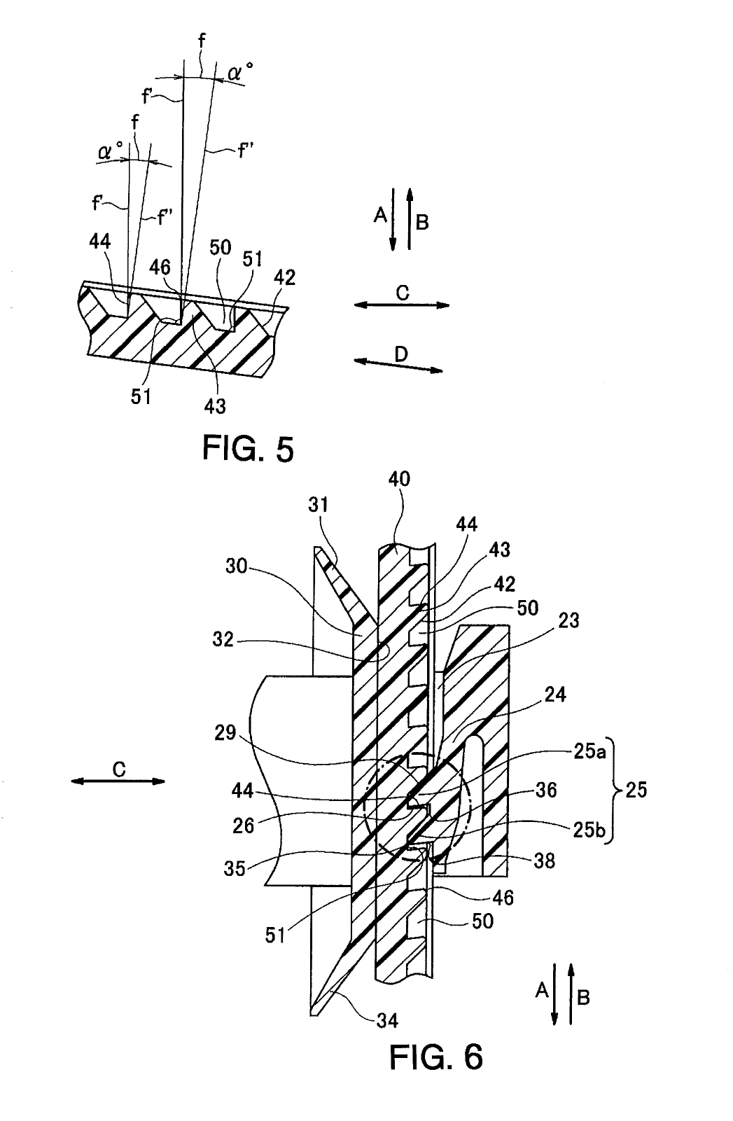

FIG. 5 is an enlarged view of portion (c) in FIG. 2. In the molded state before the band 40 has been inserted into the through-hole 23, the ratchet teeth 43 have a surface in the perpendicular direction or in direction (f′) orthogonal to both the insertion direction A of the band 40 into the through-hole 23, and the extraction direction B opposite that of the insertion direction A for pulling the band 40 out of the through-hole 23. These surfaces are used as the engagement surface 44 for engaging a buckle clasp 25 inside the through-hole 23. When the binding device 10 is integrally molded, the engagement surfaces 44 can be manufactured more easily by removing the mold in the extraction direction B.

Note that the direction (f′) of the engagement surfaces 44 is not orthogonal to the arrangement direction of the ratchet teeth 43 (the direction of arrow D in FIG. 5). In other words, the direction (f′) of the engagement surfaces 44 forms an acute angle α° (f), such as 7°, to the direction (f″) orthogonal to the arrangement direction of the ratchet teeth 43 (direction D). Because the engagement surfaces 44 form an acute angle (f), an accommodation pocket 50 with an acute angle portion 51 is formed by the ratchet teeth 43 for a buckle clasp 25. The effect of having an accommodation pocket 50 will now be explained with reference to FIG. 6.

FIG. 6 is an enlarged view of the portion in which a ratchet tooth 43 and the buckle clasps 25 engage each other after the band 40 has been inserted into the through-hole 23. When the band 40 has been inserted into the through-hole 23, the impact surface 29 of a ratchet tooth 43 which is a surface facing the insertion direction A impacts the impact surface 42 of a buckle clasp 25 which is a surface facing the extraction direction B. However, the elastic action of the buckle clasp 25 causes them to ride over each other and engage. The buckle clasp 25 and the ratchet teeth 42 face each other on engagement surfaces 26, 44 positioned on the rear sides of the impact surfaces 29, 42. As a result of engagement, a buckle clasp 25 is, for example, accommodated in the accommodation pocket 50 of a ratchet tooth 43. At this time, the action of the acute angle portion 51 formed in the accommodation pocket 50 causes the buckle clasp 25, especially the leading edge side 35, to bite more deeply into the accommo-dation pocket 50 than in an ordinary accommodation pocket without an acute angle portion 51. As a result, the engagement of the ratchet tooth 43 and the buckle clasp 25 is more secure. Therefore, this configuration improves the extraction load (retention strength) of the binding device 10 in the extraction direction B and ensures high retention strength.

Also, by providing the ratchet teeth 43 with an acute angle α° (f), the leading edge sides 46 of the engagement surfaces 44 of the ratchet teeth 43 are sharper than usual. When a ratchet tooth 43 engages a buckle clasp 25, the sharp leading edge side 46 of the ratchet tooth 43 (FIG. 4) bites more deeply into the accommodation pocket 36 of the buckle clasp 25.

In order to strengthen the engagement, an acute angle identical to angle (f) disposed in the ratchet teeth 43 can also be disposed in the buckle clasp 25. In this embodiment, as shown in FIG. 4, the leading edge side 35 of the engagement surface 26 of the buckle clasp 25 is inclined in the insertion direction A relative to the direction C orthogonal to both the insertion direction A and the extraction direction B at a predetermined angle (h) centered on the base end portion 37. As a result, the accommodation pocket 36 formed by the engagement surface 26 on the buckle clasp 25 has an acute angle portion 38. When a ratchet tooth 43 has engaged the buckle clasp 25, the ratchet tooth 43, especially the leading edge side 46, can bite more deeply than in the case of an accommodation pocket 36. Also, by providing an acute angle, the leading edge side 35, which is sharper than usual, can bite more deeply into the accommodation pocket 50 of the ratchet tooth 43.

When the binding device 10 is molded, the acute angle (f) of the ratchet teeth 43 can be easily created by providing a curved portion 28 where the band 40 and the buckle 20 connect. In other words, the other side, or the side of the band 40 opposite the buckle 20, can be inclined in the insertion direction (A) centered on the curved portion 28, and an acute angle (e) can be formed relative to direction C orthogonal to both the insertion direction A and the extraction direction B, or to the direction in which the band 51 extends in a typical binding device (see FIG. 2). An acute angle (f) with a size corresponding to the acute angle (e) in the curved portion 28 can be effectively and naturally formed in the ratchet teeth 43 by injection molding the components and then extracting the mold in the extraction direction B. In order to ensure the strength of the curved portion 28, a wiring harness anti-slippage rib 27 can be disposed in a portion. The provision of a rib 27 can effectively prevent drift of the band 40 in the vertical or horizontal direction with respect to the buckle 20.

While optional, in order to improve the insertability of the band 40 into the through-hole 23, a second curved portion 49 can be disposed to offset the curvature of the curved portion 28. The second curved portion 49 is disposed in the connecting portion between the other end portion 45 of the band 40 and the portion of the band 40 in which the ratchet teeth 43 have been arranged. The second curved portion 49 returns the curvature caused by the curved portion 28 to the original state and aligns the other end 45 with the orthogonal direction C. By aligning the end with the orthogonal direction C, the other end portion 45, which is the portion inserted into the through-hole, is aligned with the insertion direction A of the band 40 relative to the through-hole 23 when the band 40 is inserted into the through-hole 23. This improves the insertability of the band 40 into the through-hole 23.

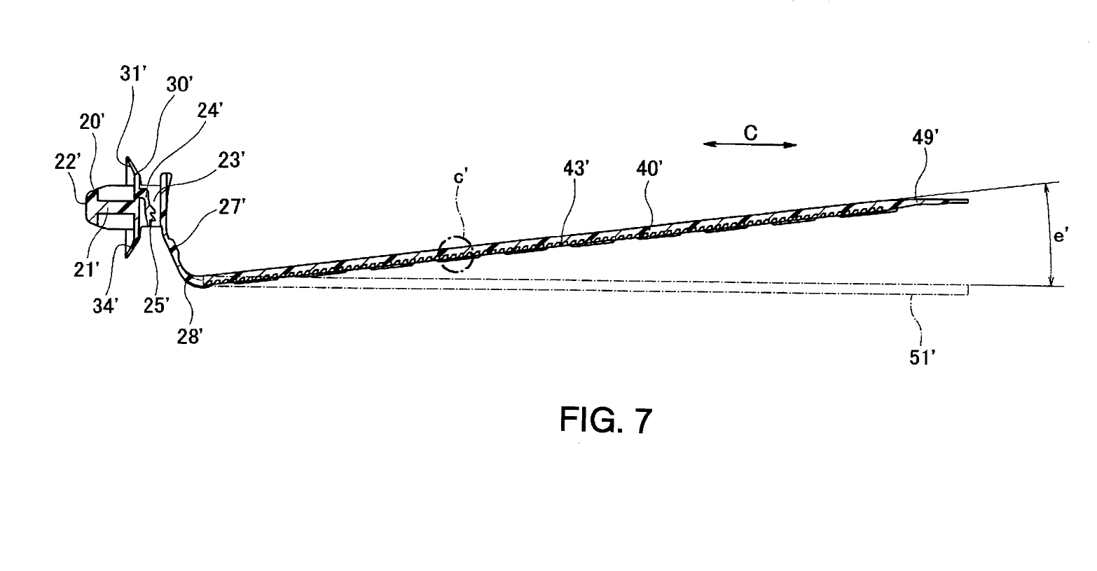

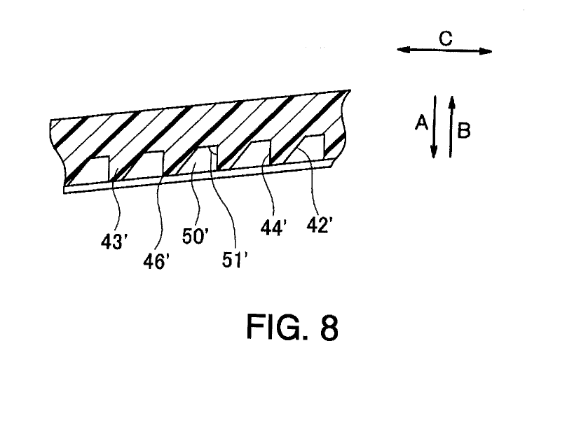

FIG. 7 and FIG. 8 show another embodiment of the invention in the present application. FIG. 7 is a cross-sectional view corresponding to FIG. 2, and FIG. 8 is an enlarged view of portion (c′) in FIG. 7. The components identical to those in the embodiment described above are denoted by the same reference numbers to which a prime symbol (′) has been affixed.

The only difference between this embodiment and the embodiment shown in FIG. 1 is that the direction of curvature for the curved portion 28′ is the opposite of that for curved portion 28. In the embodiment shown in FIG. 1, the other end of the band 40 centered on the curved portion 28 is inclined towards the insertion direction (A) and forms an acute angle (e) in the direction (C) orthogonal to both the insertion direction (A) and the extraction direction (B). In the embodiment shown in FIG. 7, this is inclined towards the extraction direction (B) and forms an acute angle (e′) in the orthogonal direction (C). Here, acute angle (e′) is the same as acute angle (e). In other words, the effect of the invention in the present application can be obtained even with the curvature shown in FIG. 7. Here, the direction of the injection molding is in the direction opposite that of the embodiment in FIG. 1. Also, the upper portion of the band 40′ in which the ratchet teeth 43′ are formed is facing direction A, and the lower portion of the band 40′ is facing direction B.

The present invention is applied to binding devices formed using integral molding, but it can also be used more broadly in binding devices manufactured using other manufacturing methods.

It will be appreciated by persons skilled in the art that the above embodiments have been described by way of example only, and not in any limitative sense, and that various alterations and modifications are possible without departure from the scope of the invention as defined by the appended claims.

What is claimed is:

1. A binding device comprising a band-like body having flexibility and a head portion disposed on an end of the band-like body in the lengthwise direction, the other end of the band-like body in the lengthwise direction being inserted into a through-hole disposed in the head portion to form a loop for securing purposes, wherein a plurality of engagement teeth is arranged on the surface of the other end of the band-like body in the lengthwise direction of the band-like body, a movable clasp being disposed on the inner portion of the through-hole, the engagement teeth being positioned to engage the movable clasp when the other end has been inserted into the through-hole in order to secure the loop, wherein the engagement teeth and the movable clasp are configured so that the movable clasp making contact is facing the engagement surface of the engagement teeth when the band-like body is inserted into the through-hole, wherein the band-like body is connected to the head portion via a curved portion, and an acute angle is formed centered on the curved portion in the direction orthogonal to both the insertion direction of the band-like body into the through-hole and the extraction direction in the molded state before the band-like body has been inserted into the through-hole, and wherein the engagement surfaces of the engagement teeth are formed as a surface running along the insertion direction and the extraction direction.

2. The binding device of claim 1, wherein a portion of the band-like body on which the engagement teeth have been arranged is substantially straight in the molded state before the band-like body has been inserted into the through-hole.

3. The binding device of claim 1, wherein the leading edge side of the engagement surface for the movable clasp is inclined with respect to the insertion direction.

4. The binding device in claim 1, wherein a side wall is disposed in the lengthwise direction of the band-like body on both side surfaces of the band-like body.

5. The binding device in claim 1, wherein a second curved portion is disposed in the connecting portion between the other end of the band-like body and a portion of the band-like body in which the engagement teeth are arranged for returning the curvature due to the curved portion to the original state.

6. The binding device in claim 1, wherein the other end of the band-like body centered on the curved portion is inclined towards the insertion direction and forms an acute angle in the orthogonal direction in the molded state before the band-like body has been inserted into the through-hole.

7. A method for integrally manufacturing the binding device of claim 1 using injection molding, wherein at least the band-like body portion in which a plurality of engagement teeth are arranged is manufactured by performing injection molding in the extraction direction.

8. The binding device in claim 1, wherein the other end of the band-like body centered on the curved portion is inclined towards the extraction direction and forms an acute angle in the orthogonal direction in the molded state before the band-like body has been inserted into the through-hole.

9. A method for integrally manufacturing the binding device of claim 8 using injection molding, wherein at least the band-like body portion in which a plurality of engagement teeth are arranged is manufactured by performing injection molding in the insertion direction.
